(19) United States
(12) Patent Application Publication
(10) Pub. No.: US 2009/0125965 A1
(43) Pub. Date: May 14, 2009

(54) Method for updating resident software in different appliances and appliances adapted to be updated by same

(76) Inventors: Frederic Albert, Rennes (FR); Hamid Boussaad, La Meziere (FR); Eric Gautier, Rennes (FR); Jean-Luc Jumpertz, Rennes (FR); Stephane Raboisson, Gahard (FR)

Correspondence Address: Robert D. Shedd;Thomson Licensing LLC, PO Box 5312, PRINCETON, NJ, 08543-5312, US

(21) Appl. No.: 11/659,044

(22) PCT Filed: Aug. 2, 2005
(86) PCT No.: PCT/EP2005/053768

§ 371 Date: Jan. 9, 2009

(30) Foreign Application Priority Data
Aug. 4, 2004 (FR) 0451779

(51) Int. Cl. H04N 7/173; G06F 9/445

(52) U.S. Cl. 725/131; 717/175

(57) ABSTRACT

The invention concerns a method enabling different software versions addressed to different decoders to be mixed in a common stream. The principle consists in defining a unique data format enabling a decoder to be updated from a stream transporting the binary segments of several software versions of the resident software, said binary segments consisting of segments common to several software versions of the resident software, said binary segments consisting of segments common to several software versions and segments specific to each of the software versions.

The present invention relates to the updating of the resident software contained in the devices. The context is more particularly the updating by distribution in a flow of the management software of the device.

Particularly in the domain of digital television reception devices commonly called television digital decoders, it is known to distribute, in flows of the MPEG transport stream type (MPEG-2 System: ISO/IEC, 1994. Generic Coding of Moving Pictures and Associated Audio: Systems, (MPEG-2 Systems Specification), November, ISO/IEC 13818-1), update versions of the resident software in the decoder. Resident software is understood to mean all the onboard software in a device used to cause the said device to operate. In this domain, a given version of the resident software is generally applied to a decoder according to, among other things, the hardware version of this decoder, the operator managing the decoder or even the planned usage for this decoder. It is usual to construct an MPEG flow, called downloading stream, containing a version of the resident software designed to update a clearly defined type of decoder.

In the beginning of the deployment of digital decoders, each update flow transported all the segments constituting the functional software and was sent to a particular type of platform. As the number of subscribers has increased, the operators have often consulted new manufacturers to diversify their decoder suppliers. These suppliers themselves sought to reduce the cost of the equipment by supplying new decoders based on new hardware versions. The hardware equipment then became heterogeneous and the need for bandwidth allocated to the downloading streams became greater.

At the same time, for different hardware versions of decoders that a manufacturer supplies to an operator, the corresponding software versions often share common segments of code. These segments are generally located more particularly in the upper layers of the software architecture (protocol stacks, applications, interface, etc.).

An identical problem is found with manufacturers who use software downloading in the production phases. Indeed, at a given moment, they can be asked to manufacture decoders for different operators on the same production line and from the same equipment hardware version, the said decoders being downloaded with different software versions, the said software versions sharing common segments of code. These segments are generally located more particularly in the lower layers of the software architecture (operating system, drivers, etc.).

The technical problem therefore involves reducing the bandwidth requirements allocated to the downloading stream and this for both the operator and the manufacturer. This problem may be expressed in the following manner:

How can an operator reduce the bit rate allocated to the flows transporting different software versions dedicated to different platforms, when these different software versions share common segments of code (protocol stacks, applications, interface, etc.)?

How can a manufacturer improve his manufacturing process by reducing the bit rate allocated to the downloading streams sent in his production facilities, when these flows are used to download different software versions dedicated to different operators on a single platform, the said different software versions having common segments of code (operating system, drivers, etc.)?

As a corollary to these problems, it is possible to add how can the downloading time be shortened to improve the experience of the user?

The invention enables different software versions designed for different decoders to be mixed in the same flow. The principle is to define a unique data format that enables a decoder to be updated from a flow transporting the binary segments of several versions of resident software, these binary segments being composed of segments common to several versions of software and segments specific to each of the software versions.

As a corollary, the procedure implemented by the loader to recover the code segments dedicated to a decoder hardware version is more complex. Nevertheless, this procedure can be improved in such a manner that the loader only seeks to recover the code segments that must be updated.

The invention relates to a method for constructing a distribution medium containing a plurality of resident software versions intended for a plurality of devices that comprises an identification step within the different resident software versions composing the plurality of the parts common to at least two resident software versions, as well as a step of dividing the different resident software versions composing the plurality into segments, as well as the assembly of these segments within a distribution medium, the segments composing a part common to at least two versions being found once within the distribution medium.

According to one particular embodiment, the invention also comprises a marking step of each segment by a means of identifying the devices targeted by the resident software version(s) of which the segment is a part.

According to one particular embodiment of the invention, the plurality of devices is a plurality of digital television reception devices.

According to one particular embodiment of the invention, the distribution medium is an MPEG transport stream.

The invention also relates to a method of acquiring all or part of a resident software version by a device having access means to a distribution medium distributed by a distribution network, the said medium comprising a plurality of segments composing a plurality of resident software versions, the method comprises an identification step within the distribution medium of at least one segment intended for the said device, as well as a downloading step of the said segment identified within the device from the said distribution medium and the storage in memory of the said segment.

According to one particular embodiment of the invention, the identification step within the distribution medium comprises a comparison step of a set of identifiers identifying within each segment the devices targeted by the resident software version to which the segment belongs and a set of resident identifiers on the device and coding its type and usage.

According to one particular embodiment of the invention, the set of identifiers contains at least one platform identifier identifying the specific type of hardware version of the device, a product identifier identifying the operator operating the device and a usage identifier identifying the planned usage of the device.

According to one particular embodiment of the invention, the device is a digital television receiver and the distribution medium an MPEG transport stream.

The invention also relates to a distribution medium of a plurality of resident software versions designed for a plurality of devices, the said software versions being divided into segments where the said distribution medium gathers the segments of the plurality of resident software versions, the segments common to at least two software versions only being present once on the medium.

According to one particular embodiment of the invention, each segment has a set of identifiers identifying within each segment the devices targeted by the resident software version to which the segment belongs.

According to one particular embodiment of the invention, the set of identifiers contains at least one platform identifier identifying the specific type of hardware version of the device, a product identifier identifying the operator operating the device and a usage identifier identifying the planned usage of the device.

According to one particular embodiment of the invention, the medium has the form of an MPEG transport stream.

The invention also relates to a device having access means to a distribution medium containing a plurality of resident software versions designed for a plurality of devices, these versions being divided into a plurality of segments within the distribution medium, the said device having means for downloading the segments present within the description medium and means for storing these segments and having means for determining the segments being part of a resident software version being intended for it among the plurality of segments present within the distribution medium.

According to one particular embodiment of the invention, the device has a set of identifiers coding its type and use and comparison means of this set of identifiers with the set of identifiers present within each segment present within the distribution medium and identifying the devices targeted by the resident software version to which the segment belongs.

According to one particular embodiment of the invention, the access means to a distribution medium are access means to an MPEG transport stream.

The invention will be better understood, and other specific features and advantages will emerge from reading the following description, the description making reference to the annexed drawings wherein:

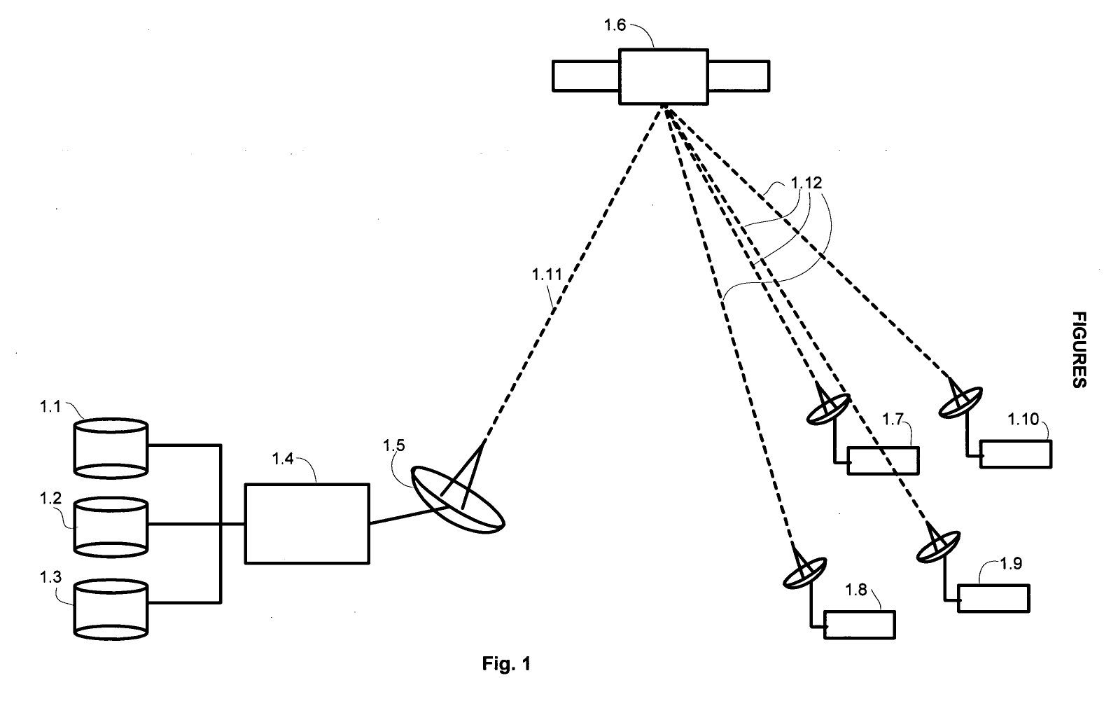

FIG. 1 shows the known architecture of a system for distributing downloading software onto a set of decoders.

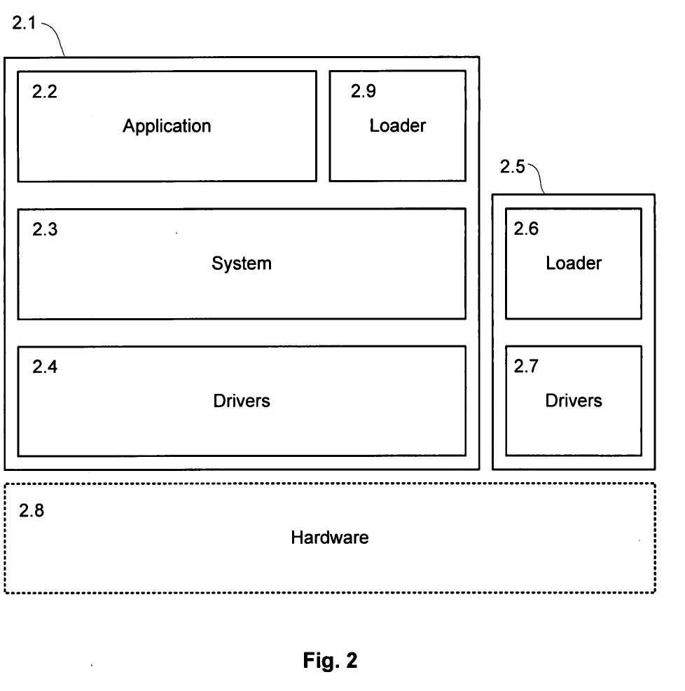

FIG. 2 shows a software architecture example of a decoder.

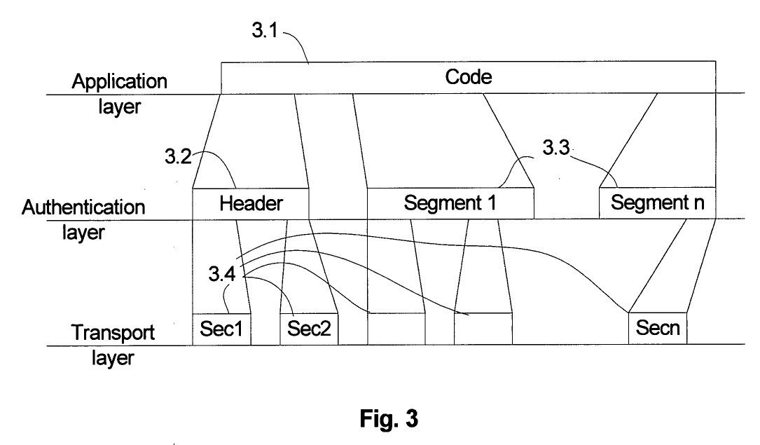

FIG. 3 shows the different division levels of the resident software in an embodiment of the invention.

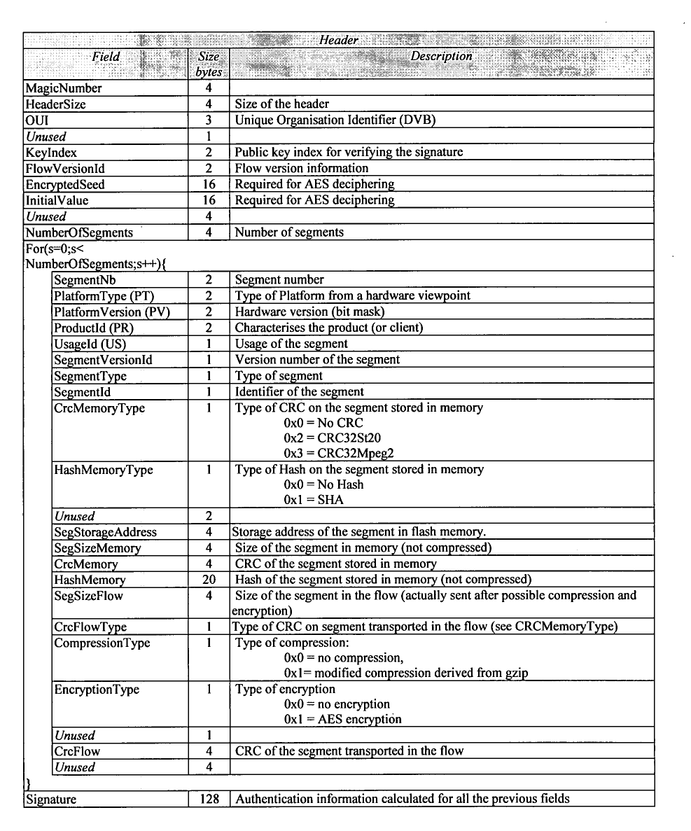

FIG. 4 shows the header segment in the embodiment of the invention.

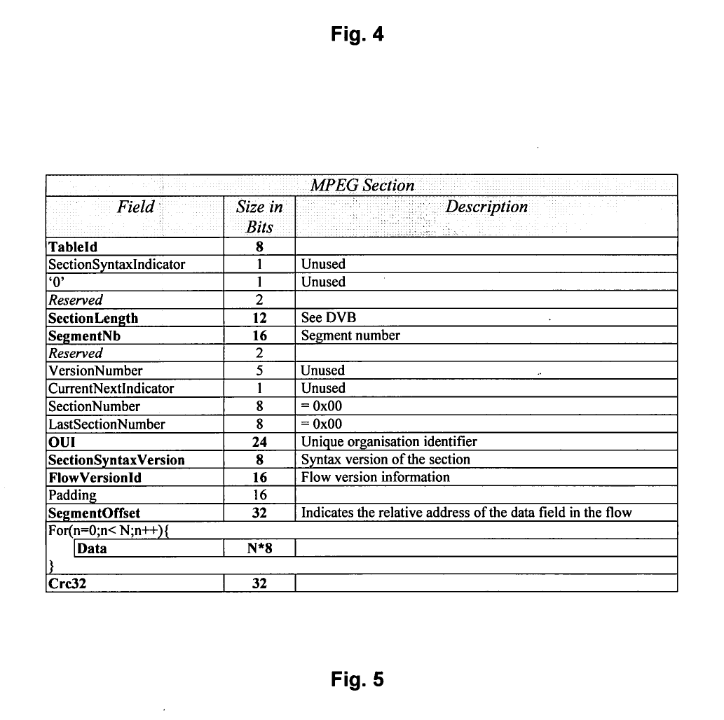

FIG. 5 shows the format of the MPEG section in the embodiment of the invention.

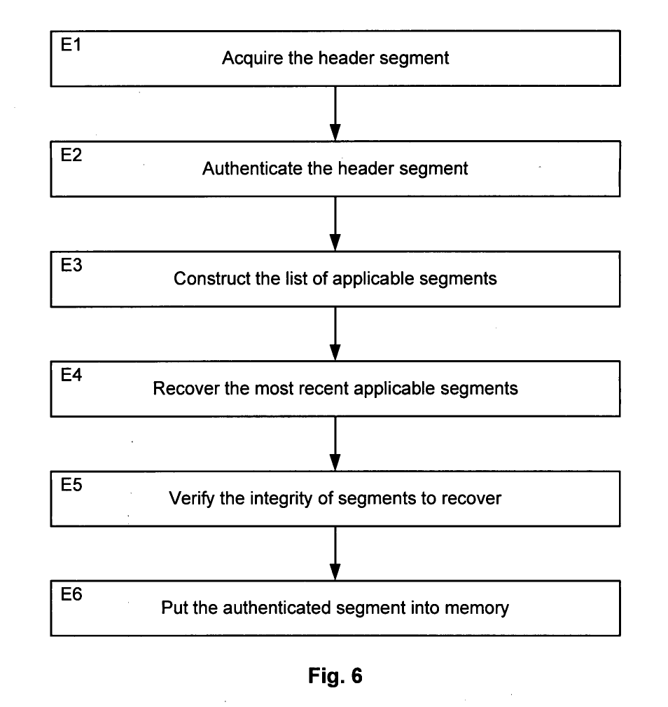

FIG. 6 shows the steps of the method used by the decoder to find the segments that it must download in the embodiment of the invention.

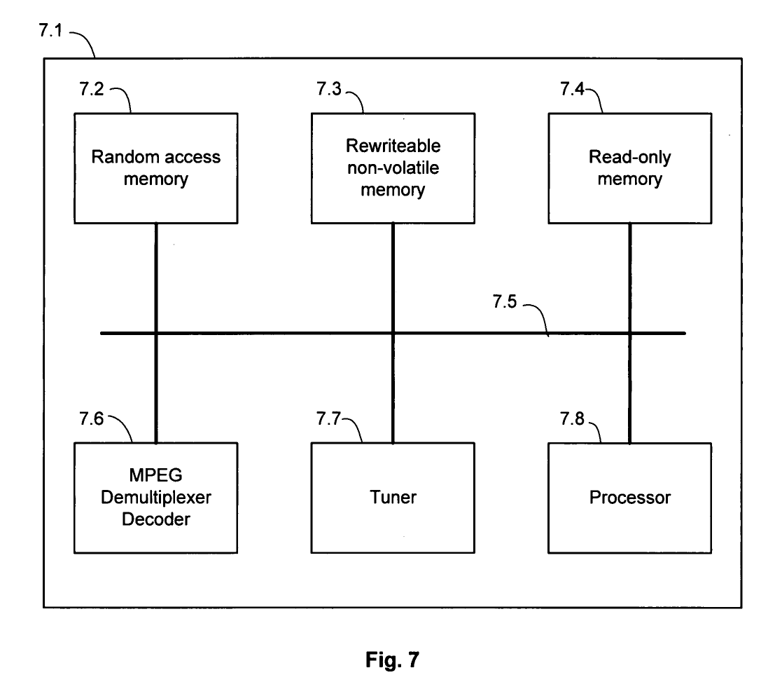

FIG. 7 shows the architecture of a decoder according to the embodiment of the invention.

An embodiment of the invention will now be described. This embodiment is located within the domain of digital television decoders, but the invention can be applied to any device having a resident software that can be updated through a general distribution means. An example can be cited of DVD players updated by a single DVD containing software versions intended for different platforms or other elements.

FIG. 7 shows the architecture of a decoder referenced 7.1 according to one embodiment of the invention. This decoder is constituted by a tuner referenced 7.7 enabling reception of the flows containing the audio and video services. This module can be a satellite, cable, terrestrial module or even a network connection interface of the IP type. The flows from this tuner will then be processed by the MPEG demultiplexer/decoder referenced 7.6. This module is responsible for verifying the rights and deciphering the flows if necessary. The required service is then isolated in the flow; indeed a single flow can contain a multiplexing of several audio and video services. Once the required service is isolated, the different basic flows are extracted from it. These flows are generally composed of a compressed video flow and an audio flow, now generally according to the MPEG-2 standard but the invention operates irrespective of the format of the services, such as MPEG-4 or other. These flows are therefore decompressed then converted to analogue signals to provide a video output and an audio output. All these operations are controlled by a resident software stored in a distributed manner between the read-only memory referenced 7.4 and the rewriteable non-volatile memory referenced 7.3. As for the random access memory referenced 7.2, it will be used as a working memory for running the resident software.

FIG. 2 diagrammatically shows the different blocks used to comprise the resident software present on the embodiment of the invention. This resident software operates on the hardware, referenced 2.8, which was described above. It is composed of two parts, a first, referenced 2.5, consists of a loader referenced 2.6 and a minimum set of drivers, referenced 2.7, enabling this loader to operate. Typically, this loader and its drivers are stored in non-rewriteable non-volatile memory so as to ensure their integrity over time. Indeed, the function of this loader is to enable the updating of the software of the decoder and must be able to operate in any case irrespective of the state of the resident software stored in the rewriteable memory, it must not be able to be corrupted.

The other part of the resident software, referenced 2.1, consists of a full set of drivers, referenced 2.4, enabling the hardware to be managed. Above these drivers is an operating system referenced 2.3 offering a set of generic functions relying on the drivers. The application, referenced 2.2, comprises the high level software that provides the user with the functions of his decoder. It is composed of a man-machine interface and implements the functions such as the change of service, management of the possible interactivity engine, interactive applications and other functions. It is common that this part also comprises a loader referenced 2.9, enabling this software group referenced 2.1 to be updated. This loader can itself be updated. Indeed, when it downloads a new version of the software system, this version can contain a new version of this loader that will be put in the memory in place of the loader referenced 2.9. If a problem occurs during this update, the loader referenced 2.6 stored in the non-volatile memory will always be able to allow a new update of the software solving the problem and finding an operational version of the software part referenced 2.1 and therefore of the loader referenced 2.9 that is part of it.

The requirement to download software into a decoder can have several reasons. The first reason is the corruption of the installed software. Indeed, the software part referenced 2.1 being stored in rewriteable memory, it is always possible that it can become corrupted. In this case, the corruption is detected on next starting up the device, which will check the integrity of the modules comprising the software by a CRC system (Cyclic Redundancy Check). If a corruption is detected in a module other than the loader, this loader will be used to download a new integral version of the software. It is possible either to update a new full version of the system software or simply modules detected as corrupt. When the loader itself is detected as corrupt, the update is entrusted to the permanent loader referenced 2.6.

Another reason for downloading is the availability of a new version of the resident software. This new version being able to correct errors present in the current version and/or add new functions to this resident software. In this case, the detection by the decoder of a new version, during its start up phase, will cause, possibly under certain conditions, this new version to be downloaded by the loader referenced 2.9 and installed in the decoder.

It is also generally possible to cause the downloading and installation of a given software version. In this case, the user, or the approved engineer after unlocking any protective system, will be able to specify the resident software version that he requires to install on the device and download it. This can be done during maintenance operations or during the preparation of the devices in the factory before delivery. In this manner, it is always possible to configure a device with a chosen system software version according to the usage for which the device is intended.

The typical downloading infrastructure is described in FIG. 1. The entirety of a software version intended for a device is constituted by different modules forming among other things the drivers, the operating system and the application layer. These modules referenced 1.1, 1.2 and 1.3 will be assembled and mixed in an MPEG transport stream on a mixer referenced 1.4. This flow will be sent by a transmission station referenced 1.5 to a satellite referenced 1.6 that will distribute it to the decoders referenced 1.7 to 1.10. The infrastructure described here is that of satellite distribution, but the diagram is the same for another type of distribution that can be cable, terrestrial or even an internal network within a manufacturing facility. In this case, the flow calculated by the mixer referenced 1.4 will be sent by a server responsible for making the signal intended for the decoder. In a standard manner, the downloading stream constructed will contain a version of the software intended for a given type of decoder but in the context of the invention it will be possible to mix modules belonging to several software versions into this flow.

A certain number of identifiers are used to mark the resident software versions and determine the relevant decoders. The following identifiers will mainly be found and play a decisive role in determining the downloading process:
The platform identifier, in fact composed of the aggregation of two identifiers, PT indicating the type of platform, which corresponds to the decoder model and PV specifying the version number in the platform type. This identifier thus enables a decoder hardware model to be accurately identified.
The product identifier PR that will generally identify the operator using the decoder. Indeed, a same hardware decoder will not use the same software depending on the operator that will deploy it.
The usage identifier US enables a same platform and a same product to differentiate between the usage that will be made of the platform. One can thus differentiate between, for example, a platform designed for a subscriber and a platform designed for testing or another purpose.

A set of these identifiers is stored in the decoder providing knowledge of the exact platform model, the operator and the usage for which this decoder is designed. The downloading streams also contain a set of these identifiers enabling the decoders, for which the software contained is created, to be known. Within the context of the invention, each segment will have its own parameter set.

In a known manner when a decoder must be updated with a new software version for the reasons described above, it will use the internal parameters enabling it to identify the flow containing the software version that is designed for it. It thus connects to this flow and checks that the platform, product and usage identifiers contained in the flow correspond to those identifiers that it possesses. In this case, it will download the software contained in the flow and store it.

Within the context of the embodiment of the invention, the updating mechanism is based on the transmission of binary segments referenced 3.3. These segments correspond to a division of the memory dumps, referenced 3.1, of the different resident software versions that are required to be mixed into the flow. These segments can correspond directly to the different modules composing the resident software versions or be the result of another mode of division. These segments of code are preceded by a header segment referenced 3.2 that describes all the code segments distributed. All the segments are transported by means of MPEG sections referenced 3.4. Indeed, the MPEG transport streams are composed of a succession of 188 byte sections.

The “header” segment illustrated in FIG. 4 is itself composed of a “header” then a loop describing each of the code segments included in the flow and a signature field that authenticates this header segment and its content.

The header of the “header” segment comprises the following fields:
“OUI” (Unique Organisation Identifier) specified by DVB (“Digital Video Broadcast”, the consortium responsible for defining the digital broadcasting standards) uniquely identifies each manufacturer and therefore each segment described by the header.
“Key Index” required to authenticate the flow when an algorithm based on public keys is used. It identifies the public key to be used to authenticate the flow.
“FlowVersionId” enables a change in the content of the flow to be known. This information can be distributed in the signalling and thus enable the decoder to start a download operation each time it changes.
“EncryptedSeed, InitialValue” information required to decipher the segments.

The following information is found for each segment:
“PlatformType, PlatformVersion” identifies the hardware platform onto which the segment must be loaded. A segment common to all the platforms will be identified uniquely by a “(PlatformType, PlatformVersion)=any” pair.
“ProductId” identifies the product or client. A segment common to all products will be identified uniquely by a “ProductId=any”.
“UsageId” identifies the usage of the decoder in the device group (subscriber, testing, etc.). A segment common to all usages will be identified uniquely by a “UsageId=any”.
“SegmentVersionId” identifies the version of the segment. It is used to determine whether a segment is already present in the decoder and does not need to be downloaded.
“SegmentType, SegmentId” corresponds respectively to the type of segment (operating system, drivers, interface, etc.) and to its identifier in the type.
“CrcMemoryType”: CRC type (Cyclic Redundancy Check) calculated on the segment stored in memory.
“HashMemoryType”: Hash type calculated on the segment stored in memory. Required to check the flow authentication.
“SegStorageAdress”: Storage address of the segment in memory.
“SegSizeMemory”: Size of the segment in memory (segment not compressed).
“CrcFlowType”: CRC type calculated on the segment transported in the flow. Required to check the integrity of the segments during reception.
“CompressionType”: Compression type calculated on the segment transported in the flow. Determines whether or not the segment is compressed and what compression algorithm was used.
“EncryptionType”: Type of encryption on the segment transported in the flow. Determines whether or not the segment is encrypted and what encryption algorithm was used.
“CrcFlow”: CRC of the segment transported in the flow.

Finally, there is:

“Signature”: information enabling the flow to be authenticated.

The transport format is based on the transport format in MPEG sections shown in FIG. 5. It contains the “OUI”, “SegmentNb”, “FlowVersionId” information described above. This information will be used to recover the data transmitted in the flow.

In this manner, it is possible in the same flow to mix the segments belonging to different memory dumps corresponding to different versions of resident software. Each segment having its own set of parameters PT, PV, PR and US, the destination of each segment is defined. Moreover, the fact of giving some of these parameters the value “any” does not duplicate the segments to share between different software versions. Indeed a shared segment between different software versions of a given product intended for all the hardware platforms will be marked with PR equal to the value of the product and (PT,PV) equal to “any” and the same for the other parameters. One begins to do this in the different resident software versions to assemble in the flow, by identifying the parts common to at least two of these versions. Each module is indeed marked by configuration, or other means, with a set of parameters PT, PV, PR and US specifying its destination. The analysis of these parameters identifies the modules common to several versions. Then, when these modules are divided into segments, each segment will be marked with the parameter set PT, PV, PR and US corresponding to it, the common segments not being duplicated during the construction of the distribution medium, here the MPEG flow.

The main downloading steps are illustrated in FIG. 6.

A first step, referenced E1, consists of acquiring the header segment by a section filtering on the fields “TableId, SegmentNb=0, OUI, SectionSyntaxVersion, FlowVersionId”.

A second step referenced E2 consists in checking the authentication of this header segment thanks to its signature.

A third step reference E3 consists in constructing the list of segments corresponding to the decoder carrying out the downloading by successively extracting (see table below):
1. the segments dedicated to the platform (PT,PV), product PR and usage US of the decoder carrying out the downloading.
2. the segments dedicated to the platform, product, where US=any.
3. the segments dedicated to the platform where (PT, PV)=any. In this case the value of US is ignored
4. the segments dedicated to the product, usage where (PT, PV)=any.
5. the segments dedicated to the product where (PT, PV)=any, US=any.
6. the generic segments, namely where (PT, PV)=any, PR=any and irrespective of the value of US.

| Platform | Product | Usage | |
|---|---|---|---|
| PT, PV ≠ any | PR ≠ any | US ≠ any | 1 |
| | | US = any | 2 |
| | PR = any | US not taken into account | 3 |
| PT, PV = any | PR ≠ any | US ≠ any | 4 |
| | | US = any | 5 |
| | PR = any | US not taken into account | 6 |

A fourth step referenced E4 consists, for an update due to the availability of a new software version, in only retrieving from this list the segments for which the “SegVersionId” is different from the “SegVersionId” stored in memory and corresponding to the previous update. If the downloading is due to a corruption of some segments in the decoder, the version recovered is the same as the one that is already present and the segments identified as corrupt will be recovered.

A fifth step consists in checking the integrity of each of the segments recovered thanks to the CRC of each segment.

A sixth step consists in storing the downloaded segments in memory.

Although the embodiment of the invention lies within the framework of digital television decoders, it will appear to those skilled in the art that the invention can be applied to all devices having updating capacities of their resident software via a data distribution network.

1. Method for constructing a distribution medium containing a plurality of resident software versions intended for a plurality of devices,
wherein it comprises at least the following steps:
identification within the different resident software versions composing the plurality of the parts common to at least two resident software versions,
dividing the different resident software versions composing the plurality into segments,
assembly of these segments within a distribution medium, the segments composing a part common to at least two versions being found once within the distribution medium.

2. Method according to claim 1 also comprising a marking step of each segment by a means of identifying the devices targeted by the resident software version or versions of which the segment is a part.

3. Method according to claim 2, wherein the plurality of devices is a plurality of digital television reception devices.

4. Method according to claim 3, wherein the distribution medium is an MPEG transport stream.

5. Method for acquiring all or part of a resident software version by a device having access means to a distribution medium distributed by a distribution network,
wherein the said medium comprising a plurality of segments composing a plurality of resident software versions, the method comprises at least the following steps:
identification step within the distribution medium of at least one segment intended for the said device,
downloading of the said segment identified within the device from the said distribution medium,
storage in memory of the said segment.

6. Method according to claim 5, wherein the identification step within the distribution medium comprises a comparison step of a set of identifiers identifying within each segment the devices targeted by the resident software version to which the segment belongs and a set of resident identifiers on the device and coding its type and usage.

7. Method according to claim 6, wherein the set of identifiers contains at least one platform identifier identifying the specific type of hardware version of the device, a product identifier identifying the operator operating the device and a usage identifier identifying the planned usage of the device.

8. Method according to claim 7, wherein the device is a digital television receiver and the distribution medium an MPEG transport stream.

9. Distribution medium of a plurality of resident software versions designed for a plurality of devices, the said software versions being divided into segments,
wherein the said distribution medium gathers the segments of the plurality of resident software versions, the segments common to at least two software versions only being present once on the medium.

10. Medium according to claim 9, wherein each segment has a set of identifiers identifying within each segment the devices targeted by the resident software version to which the segment belongs.

11. Medium according to claim 10 where the set of identifiers contains at least one platform identifier identifying the specific type of hardware version of the device, a product identifier identifying the operator operating the device and a usage identifier identifying the planned usage of the device.

12. Medium according to claim 11 having the form of an MPEG transport stream.

13. Device having access means to a distribution medium containing a plurality of resident software versions designed for a plurality of devices, these versions being divided into a plurality of segments within the distribution medium, the said device having means for downloading the segments present within the description medium and means for storing these segments,
wherein it has means for determining the segments being part of a resident software version being intended for it among the plurality of segments present within the distribution medium.

14. Device according to claim 13, wherein the device has a set of identifiers coding its type and use and comparison means of this set of identifiers with the set of identifiers present within each segment present within the distribution medium and identifying the devices targeted by the resident software version to which the segment belongs.

15. Device according to claim 14, wherein the access means to a distribution medium is access means to an MPEG transport stream.
